(19) United States
(12) Patent Application Publication
(10) Pub. No.: US 2009/0037296 A1
(43) Pub. Date: Feb. 5, 2009

(54) Mobile Collegiate Commerce System

(76) Inventor: Randy Jaramillo, Rancho Santa Margarita, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/185,762

(22) Filed: Aug. 4, 2008

Related U.S. Application Data
(60) Provisional application No. 60/953,969, filed on Aug. 3, 2007.

(51) Int. Cl. G06Q 30/00

(52) U.S. Cl. 705/27; 705/26

(57) ABSTRACT

A mobile commerce system and method includes a fronted software that enables a variety of displays on a mobile device. The displays display information about college-related merchandise. The information can be tailored for a specific college to which the user has pre-approved access, via a user account management module employed on a server associated with the college. A backend, including a database, stores a product catalogue of the merchandise, which is accessible by the user operating mobile device, and which is transmitted on request to the user for display and operation by the mobile device.

### CROSS REFERENCE TO RELATED APPLICATIONS

The present application claims priority under 35 U.S.C. §119 to U.S. Provisional Application Ser. No. 60/953,969, filed Aug. 3, 2007, entitled MOBILE COLLEGIATE COMMERCE SYSTEM, the disclosure of which is incorporated herein by reference.

### BACKGROUND

This disclosure relates generally to mobile commerce systems, and more particularly to a system and method for conducting commerce via a mobile handset connected to a wireless network.

The most powerful and compelling opportunity for the collegiate consumer market to embrace is identifying new and innovative channels for extending the reach of merchandising college-oriented goods. Current college merchandising platforms consist mainly of brick and mortar distribution channels provided by strategic bookstore locations, along with limited online shopping categories. However, such physical distribution channels severely limit a college's market and revenues from merchandising college-oriented goods.

The details of one or more embodiments are set forth in the accompanying drawings and the description below. Other features and advantages will be apparent from the description and drawings.

### SUMMARY

In general, this document discusses a mobile collegiate commerce system and method.

In one implementation, a method for . . . is disclosed. The method comprises . . .

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a mobile collegiate commerce system.

FIGS. 2-5 illustrate various interfaces of a system.

Like reference symbols in the various drawings indicate like elements.

### DETAILED DESCRIPTION

This document presents a mobile collegiate commerce system and method, leveraging wireless communications and mobile computing technologies to provide a mobile shopping experience to drive grassroots merchandising campaigns for collegiate institutions. The system and method enable brand extension of a private label, as well as merchandising of selected products and promotions with campus vendors, retailers, services or events, further enabling the alumni community and fan base to be reached to a broader degree. Channel distribution can be aligned with the university in its entirety, or by professional schools within the university (Business, Engineering, Dental, Law school, etc.), departments within a university (Athletics, etc.), or social networks (Greek Communities). The system and method are agnostic with respect to mobile device or wireless communication carrier. A mobile device can include a mobile phone, a mobile computing device, or any other mobile communication device.

Whether it be shopping, fundraising or the attraction to the network created by Referral Programs, a revenue model for the system and method is multi-faceted with transaction fees, advertising fees, sponsorship licensing and revenue sharing to support and grow the initiatives.

The system and method are configured to stimulate the purchasing powers of the emotional buyer at any time and any location, while at a game or event related to the college or university, etc. Implementations of the system and method can reach onsite game attendance as well as the audience from all broadcast components, i.e. product promotion on the scoreboard, announced by the public address system, color commentators on TV and radio, and commercials. A consumer can merely pick up their mobile device and purchase the promoted product, anytime and anywhere.

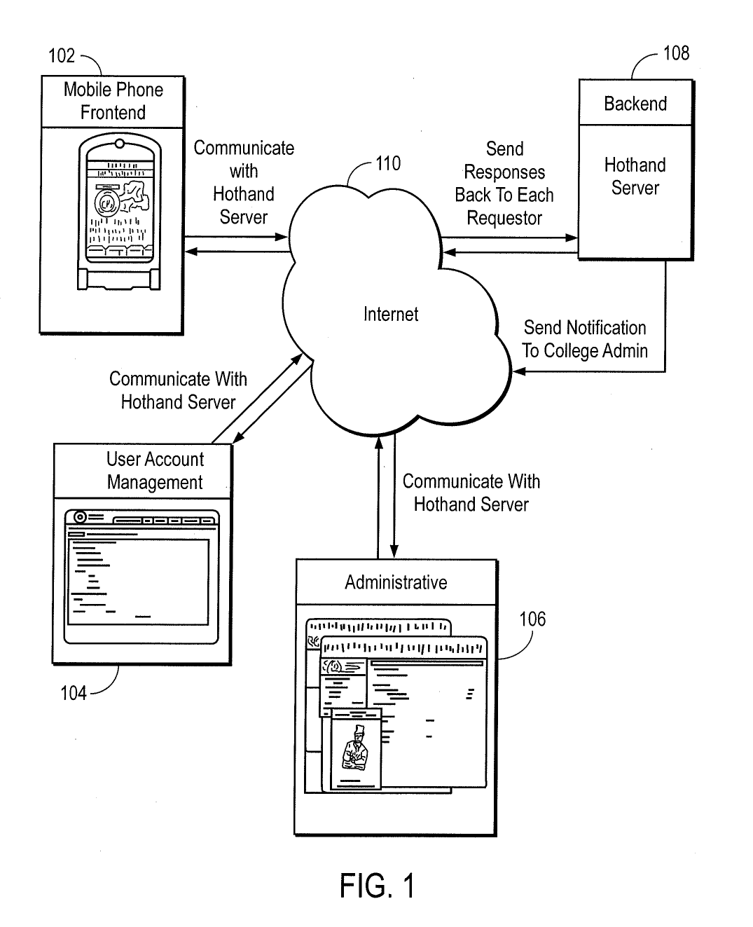

In exemplary implementations, as shown in FIG. 1 a system includes a mobile phone front-end 102, a user account management module 104, an administrative module 106, and a backend 108, all of which communicate wirelessly or via wired connection through the Internet 110. These components are discussed in further detail as follows:

The mobile phone front-end 102 is an interface used by the mobile phone customer and is very similar to the media-rich mobile phone interfaces. The customer is presented with a menu of choices for viewing advertisements, coupons, information, and the ability to purchase products through the phone (new with the college interface). To make purchases using the mobile phone, the user has to have enabled that capability through user account manager. This interface is presented to the user through the mobile phone's web browser. Other implementations include a thin client running on the phone.

The mobile phone front-end 102 can be implemented on a cellular phone, personal digital assistant with wireless communication capabilities, and any other handheld or wireless device with processing and wireless communications capabilities and a media-rich display.

User account management 104 is enabled by a user before they can make purchases with their phone at the college's mobile site. The user goes online to provide credit card information, shipping information, and a special “buy-now” password which will be used in a mobile device graphical user interface 600 as described below. User account management 104 is preferably handled through a specialized website, which allows the user to login and set his preferences from a PC web browser. Other implementations include this functionality being resident on the mobile phone interface (both web-based and thin client based).

The administrative module 106 is a computerized system used by the university bookstore personnel to add and remove products that are to be sold through the mobile phone front-end 102. This is also where the university will retrieve sales information. The administrative module 106 is preferably a web based interface that the administrator logs into with a PC web browser, which interacts with a merchandising and customer databases that stores the ads, coupons, information, and products.

The backend 108 is a piece is software that only runs when a mobile phone user makes a purchase using their phone. This software verifies the “buy-now” password and stores the purchase information into the sales database for later retrieval by the administrative module 106. In addition, the backend 108 software sends notification to the college or university indicating that a purchase has been made so that they can fulfill the order. This software runs on the web server in response to mobile phone front-end 102 actions such as when a user purchases a product with his mobile phone.

The system and method can be used for a variety of applications, including but not limited to: 1) mobile shopping from a “bricks and mortar” bookstore; 2) mobile purchasing of event tickets; 3) alumni connection and targeted social networking based on alumnus status; 4) student connected and targeted social networking based on student status; 5) fundraising; 6) shopping from on-campus merchants and surrounding merchants of an institution using a merchant program; 7) generating event schedules such as sports, concerts, performances, etc.; 8) generating and transmitting event updates to one or more mobile devices; 9) executing referral rewards programs; and 10) affinity programs for each school of the college.

Some or all of the applications above can be implemented according to U.S. patent application Ser. No. 10/094,379, entitled “DEVICES, SYSTEMS, AND METHODS FOR SOLVING CHALLENGES IN TELECOM SALES AND MARKETING,” and/or to U.S. patent application Ser. No. 11/139,288, entitled “MOBILDE COMMERCE FRAMEWORK,” the contents of each being incorporated herein for all purposes.

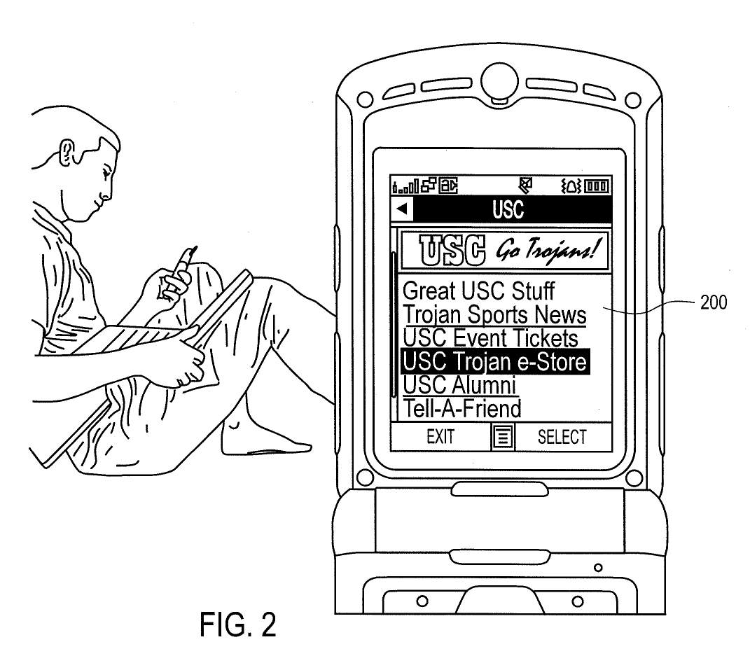

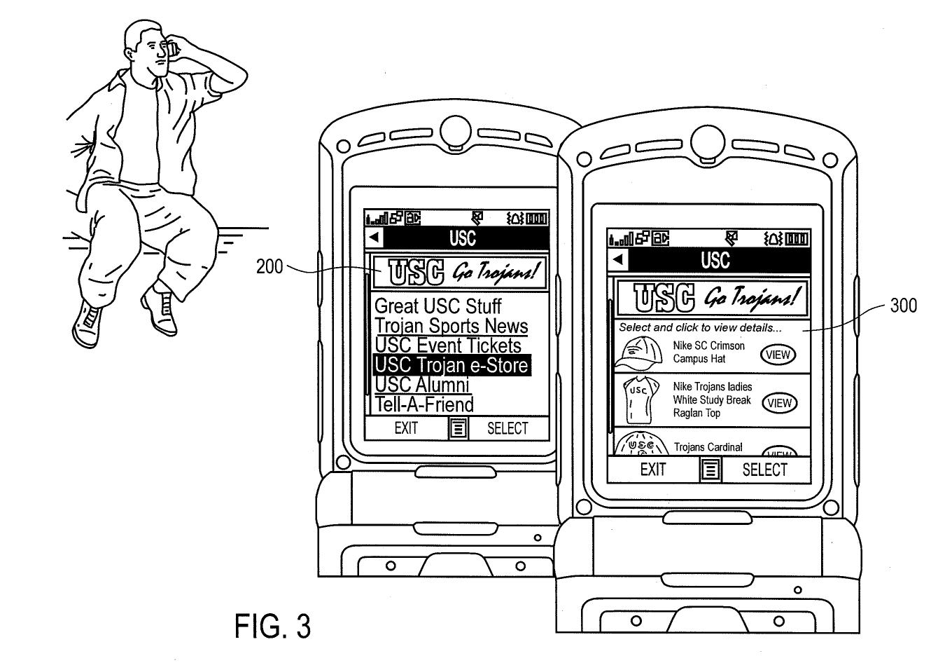

FIGS. 2-5 illustrate various interfaces used by the mobile phone front-end 102. FIG. 2 illustrates a first graphic user interface (GUI) 200 displaying functionality that allows a user to scroll to a number of options related to a college or university, including a virtual store (“e-store”). Thus, via a mobile device, a user can access a merchandising function related to the college or university. FIG. 3 illustrates a second GUI 300, navigable from the first GUI 200, that displays functionality that allows a user to navigate among a variety of products for sale to the user from the merchandising function. The products are related to the college or university.

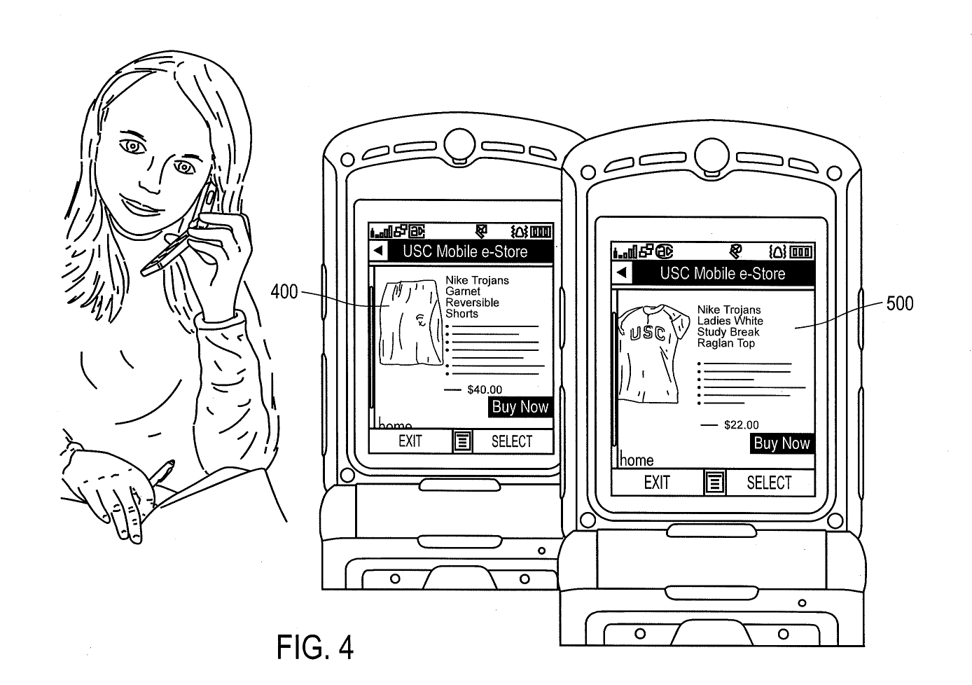

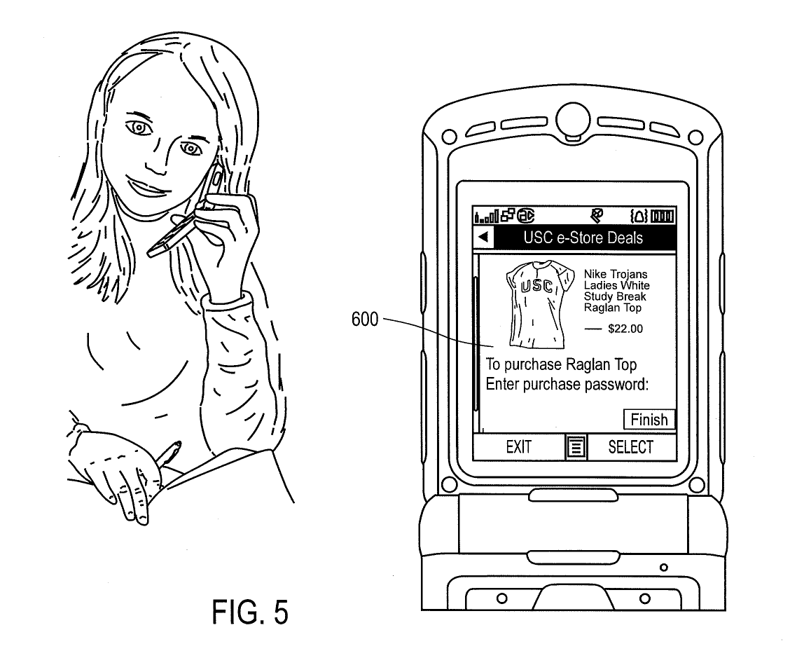

FIG. 4 illustrates third and fourth GUIs 400 and 500, each displaying functionality that enables a user to view detailed information about a specific product, which is either selected by the user or served up (i.e. “pushed”) to the user based on user subscription information U.S. patent application Ser. No. 10/094,379, entitled “DEVICES, SYSTEMS, AND METHODS FOR SOLVING CHALLENGES IN TELECOM SALES AND MARKETING,” and/or to U.S. patent application Ser. No. 11/139,288, entitled “MOBILDE COMMERCE FRAMEWORK.” FIG. 5 illustrates a GUI 600 that displays functionality to enable a user to enter a purchase password into the GUI 600 on the mobile device, to be able to purchase a selected item from the college or university-related electronic merchandising store.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A mobile collegiate commerce system that enables commerce related to a college through the Internet, the system comprising:
a front-end software module hosted on at least one mobile device, the fronted software providing media-rich graphical user interfaces through which a user can browse and select from a variety of college related merchandise that is represented in the media-rich graphical user interface;
a user account management module hosted on a server computer associated with the college, and adapted to receive and store user account information, the user account information including at least one identifier related to the user and a unique password that can be entered into the fronted software by the user to purchase one of the variety of college related merchandise; and
an administrative module hosted on the server computer associated with the college, and adapted to store and serve information related to the variety of college related merchandise, the administrative module further including sales information related to a buying history of the user.

2. The system in accordance with claim 1, further comprising a backend software module, in communication with the server computer associated with the college, the backend software module including a database that stores information about the user, and logic to verify for the administrative module the unique password entered into the fronted software module by the user.

3. A method for college-related commerce through the Internet, the method comprising:
storing merchandise data that represents a variety of merchandise related to a college, the merchandise data including an image, a text description, and pricing information for each product in the variety of merchandise, the merchandise data being formatted for display on any of a number of mobile device displays;
serving, through the Internet to a mobile device, at least a portion of the merchandise data upon request from a user through the mobile device;
receiving a request for purchase of a specific product from the variety of merchandise, the request for purchase including a unique password that enables a purchase transaction to be executed; and
confirming a sale of the specific product to the user based on verification of the unique password received from the mobile device through the Internet.

4. The method in accordance with claim 3, further comprising reporting the sale of the specific product to a computer associated with the college.
